(19) United States
(12) Patent Application Publication
(10) Pub. No.: US 2002/0107026 A1
(43) Pub. Date: Aug. 8, 2002

(54) Dynamic predictive resource reservation in wireless networks

(76) Inventors: Prathima Agrawal, New Providence, NJ (US); Jasmine Chennikara, Morristown, NJ (US); Toshikazu Kodama, Morristown, NJ (US); Tao Zhang, Fort Lee, NJ (US)

Correspondence Address: Orville R. Cockings, Esq., Telcordia Technologies, Inc., Room 1G-112R, 445 South Street, Morristown, NJ, 07960, US

(21) Appl. No.: 09/737,400

(22) Filed: Dec. 15, 2000

(51) Int. Cl. H04Q 7/20

(52) U.S. Cl. 455/453; 455/452; 455/436

(57) ABSTRACT

A method for reserving resources in a wireless network. The method is implemented in a base station by moving the function of predicting and reserving resources from the radio dependent layer to a radio independent layer. In accordance with our method resources currently being used and being demanded are monitored. The monitored data is then used by a reservation handler to predict future resource demand. The future resource demand is then estimated by the reservation handler for both radio dependent and radio independent layers. In estimating future resources we use a Wiener process model and incorporate instantaneous changes in the resource usage and demand so that call fluctuations are accounted for.

### FIELD OF THE INVENTION

This invention generally relates to provision of services in mobile wireless Internet Protocol (IP) networks and more specifically relates to allowing mobility of service for subscribers in such wireless networks.

### BACKGROUND

Two recent technological hallmarks have been the development of the personal computer and the wireless mobile telephone or cellular phone. In fact, the last ten years of the twentieth century has been marked by unprecedented growth in the demand for personal computers, particularly laptops, and wireless telephones (or cell phones). The personal computer owes its popularity mainly in part to its ability to access and process relatively large amounts of data, its price, and its size, especially in the case of laptops. Specifically, a personal computer allows for accessing and processing large amounts of multimedia information available, for example, via the Internet from the top of a desk or the lap of a user. Consumers via the Internet can access, send, and receive email messages, preview movies, research intended purchases, etc. In essence the Internet and personal computer have made the consumer smarter through access to a heretofore unimaginable plethora of information.

Cell phones, on the other hand, have allowed users mobility previously unavailable by wireline phones. Specifically, whereas a wireline phone restricts the user's mobility to the location of the phone, a user may make and receive calls from a cell phone even while roaming over a very large geographical area such as the contiguous United States. In addition, as the user roams geographically the quality of service is maintained at a fairly high level.

Merging the mobility of the cellular network with the information capability and accessibility of the Internet has become a main focus of the communications industry. In particular, in recent years considerable research has been directed to developing mobile protocols that would allow seamless access to the multimedia services available on the Internet anytime and anywhere.

The Internet is a packet data network in which the Internet Protocol (IP) defines the manner in which a user is connected to the Internet so as to access, transmit, and receive information from other users or resources connected to the Internet. In particular, in accordance with IP each network access point is identified by an IP address. When a user attaches to a particular network access point the user, more precisely, the user's terminal, is given an IP address. The addresses available at access point are assigned geographically. Consequently, as a user roams geographically the user's point of attachment to the network changes which in turn requires the user's IP address to change. Further, information destined for a user, or resource, is packetized with each packet having the IP address of the user, more accurately the user's terminal, in a header. As packets traverse the network, the IP address included in the header is used to route the packet to its destination. Thus, as a user roams and her IP address changes the route of the packet changes, which in turn may affect the quality of service for some multimedia services, i.e., real time services, as there is no guarantee that network resources required to support the service are available. At a fundamental level IP was not designed with mobility in mind as evidenced by the manner in which IP addresses are assigned.

In contrast, the wireless telephone network is a circuit switched network with each user's telephone number serving as a unique access identifier. Consequently, as the user roams geographically the user's identity is unchanged thereby allowing the network to easily track the user's movement, establish new circuits in anticipation of the user moving to a different geographic region, and maintain the needed quality of service. In addition, in the wireless telephone network calls between users are routed through the network on circuits that are established for the duration of the call. In other words, a path is established in the network for exclusively carrying each call thereby assuring the user of the bandwidth needed for the service.

Given the fundamentally different approaches underlying the manner in which access is provided to the Internet and to the wireless telephone network and the manner in which paths are established and signals routed through each of these networks, many issues need to be resolved before multimedia services can be provided over a wireless IP network. Nonetheless, forecasts indicate that users or consumers will ultimately desire accessing currently available and future multimedia services available via the Internet while being mobile, i.e., combining the cell phone mobility with the processing power of the personal computer. As such, there has been an international effort to provide mobile access to Internet protocols.

Responding to this apparent demand, the International Telecommunications Union (ITU) promulgated International Mobile Telecommunications—2000 (IMT-2000) global standards to allow for wireless access to multimedia information or services available via the Internet in much the same way consumers are use to using their cell phones, so called third generation wireless (3G wireless) services. The IMT-2000 standards have made significant progress in defining a common radio system architecture, including services, interfaces, and radio spectra. For example, at the physical layer, IMT-2000 includes standards on the frequency of the chip sets used to support the services and the radio frequency spectrum, which will be used for the services. By physical layer we refer to the first layer of the 7-layer Open System Interconnect (OSI) reference model wherein the layers are ordered as follows: layer 1 is the physical layer and the lowest layer in the stack, layer 2 is the link layer and above layer 1, layer 3 is the network layer and above layer 2, layer 4 is the transport layer and above layer 3, layer 5 is the session layer and above layer 4, layer 6 is the presentation layer and above layer 5, and layer 7 is the applications layer and the highest layer. IMT-2000 includes definitions on upper layer protocols, but mostly for circuit based networks. IMT-2000 also includes standards on Time Division Multiple Access (TDMA) and Code Division Multiple Access (CDMA) technologies.

The ITM-2000 standard has spawned numerous industry organizations and groups all with the general goal of developing applicable technical specifications for supporting CDMA 2000, W-CDMA, and third generation TDMA systems. Some of these organizations include the 3^{rd} Generation Partnership Project (3GPP), the 3^{rd} Generation Partnership Project 2 (3GPP2) and the Mobile Wireless Internet Forum (MWIF). These organizations are directing their efforts to solving the problems that will be encountered in trying to provide 3G wireless multimedia services or mobile access to Internet services.

In a conventional prior art wireless network such as shown in FIG. 1A, a plurality of base stations 10 transmit or send information over the air to a plurality of mobile units 20. The range within which a mobile unit 20 can reliably receive information from a base station 10 defines a cell 21. As illustrated in FIG. 1A the cells 21 may be depicted as a honeycomb structure. As a mobile unit 20₂, for example, roams and moves further away from a base station 10₂ corresponding to cell 21₂ for base station 10₂, signal strength decreases. Further, as the mobile moves from one cell to another, the mobile station needs to switch from its serving base station, the base station for the cell it currently is in, to a target base station, the base station for the cell that it's moving to. The process of the mobile switching base stations is known as handoff.

Handoff can be hard or soft. In a hard handoff a user may receive data from only one base station at any given time. In other words, there is a single wireless data transport path for a user at any given time and the path has to change when the user moves from one cell to another. This could cause data in transit, e.g., data that has been sent to the previous serving base station, to be lost during hard handoff therefore causing performance degradation.

In a soft handoff, the user seamlessly switches from one base station to the next without any perceptible degradation in service. During a soft handoff a mobile user communicates with multiple base stations simultaneously. Therefore, a user may be able to switch to a new base station without data loss. Soft handoff is the method of choice employed in the conventional CDMA wireless network. In addition, soft handoff must be supported in 3G wireless networks, as it would be awfully inconvenient for a user's service, e.g., a video conference, to be disrupted each time the user switches base stations.

In addition to providing for seamless service, soft handoff also allows cells to cover a larger geographic area. This is the case because during soft handoff the mobile unit receives signals from at least two base stations and combines these received signals to obtain the information intended for the user. Because it receives two or more signals, each signal can be at a lower level than if the mobile were receiving only one signal. Accordingly, each base can be allowed to cover a larger geographic area.

The network of FIG. 1B is currently able to support cellular telephony and limited data transmissions, e.g., 9.6 kb/s for GSM and 14.4 kb/s for CDMA, and is usually referred to as 2G wireless network. With reference to FIG. 1B we will illustrate how soft handoff occurs in today's network. A user's mobile unit 20 is communicating with its serving base station 105 in the corresponding cell 21₅. The base station 10₅, and probably mobile 20, monitor the signal strength of the mobile unit 20 and when the mobile's signal strength drops below a pre-specified level soft handoff is initiated. That is, as the mobile enters the soft handoff region 33, the base station 10₅ and the mobile unit 20 together initiate the appropriate steps through a base station controller 35 and a mobile switching center 40, if necessary, in circuit switched network 47 to locate the target base station 106 for the neighboring cell 21₆ serving the same soft handoff region 33. Note that the mobile switching center would not be included in soft handoff, given the current illustrative example, because both base stations are controlled by the same base station controller. Identical information intended for the mobile unit 20 is then routed to both the target base station 10₅ and the serving base station 10₆. Both base stations in turn transmit the identical information to mobile unit 20. The mobile unit 20 then combines the signal to produce the information intended for the user. As the mobile unit 20 leaves the soft handoff region 33 and enters the target cell 21₆, soft handoff is terminated and the target base station 10₆ becomes the only base station serving the mobile unit 20. In a similar manner the mobile unit is handed from base station to base station as the unit roams from cell to cell.

Ultimately the network architecture of FIG. 1B will transition to the IP-based autonomous wireless base stations network of FIG. 1C. In comparing the architecture of FIG. 1C to FIG. 1B, we note the following important differentiating features of FIG. 1C: (1) base stations 100 function autonomously, i.e., there are no base station controllers or mobile switching centers to centrally control the base stations; (2) the backbone network 107, including connections 117 that interconnects the base stations 100 is an all IP network, as opposed to a circuit switched network; and (3) the base stations are capable of performing IP layer processing, e.g., forwarding packets based on information in the IP headers, signaling, and mobility management.

Of particular import to the present invention is the reservation of resources needed within a wireless network during handoff. In order for handoffs to occur the target or new cell must have enough resources, e.g., radio channels, radio channel capacity, bandwidth, IP addresses (if mobile units in the new and previous cells use disjoint sets of IP addresses), etc., available to accept, at some predetermined quality of service level, the entering mobile unit without significantly degrading the quality of service of mobiles or users already supported by the target cell. A mobile call already in progress may be aborted during handoff because the target cell cannot allocate sufficient resources to support the entering mobile. For example, a user on a videoconference in cell 21₅ requires sufficient bandwidth in cell 21₆ to support the videoconference. If cell 21₆ does not have the bandwidth necessary to support the videoconference, then the videoconference will end for this user once he moves beyond reach of his current serving base station 10₅. Forced termination of an on-going call due to handoff is more undesirable, from a user's perspective, than rejecting a new call. Thus, low handoff blocking probability is a key requirement in wireless networks. Reserving resources for future handoff calls is an effective way to reduce handoff call blocking probability.

Existing resource management mechanisms for supporting handoff in wireless networks fall into the following categories:

Non-reservation Mechanisms—A non-reservation mechanism is one in which free resources are assigned if there is at least one call that requests it. In other words, a base station does not reserve any resources for handoffs or handoff calls.

Reservation-based Mechanisms—A predetermined amount of network resources are set aside for use only by handoff calls.

Reservation-based mechanisms can be divided into two classes. The first class is generally referred to as fixed reservation. With fixed reservation a fixed amount of resources are reserved for handoff calls. The second class is generally referred to as dynamic (adaptive) reservation. With dynamic reservation the amount of resources reserved or available depend on the amount of resources that will be required by handoff calls.

Existing methods for dynamically predicting and reserving resources for future handoff calls can be classified into collaborative and local methods. Collaborative methods require a base station to collaborate with other base stations to make resource reservation decisions. They typically require each base station to gather real-time information on the behaviors of mobile stations in neighboring cells. Such information may include mobility patterns and traffic volumes of mobile stations in neighboring cells, the number of mobile stations or the number of calls in each service class that are expected to be handed off from a neighboring cell. Collecting such information could become difficult when mobile stations' velocities vary widely and users have access to multimedia services, as expected in IP-based multimedia wireless networks. Frequent exchange of mobile station mobility information among the base stations could increase overall wireless system complexity and overhead, especially in IP-based picocellular networks.

A recent method that uses only locally available information to make reservation decisions has been proposed by Luo, X., et. al., in their paper entitled “A Dynamic Pre-Reservation Scheme for Handoffs with GoS Guarantee in Mobile Networks”, IEEE International Symposium on Computers and Communications, July 1999 (hereinafter Luo). This method assumes that the arrival process of handoff requests into a cell is a Poisson process, the holding time of each handoff call in each cell is exponentially distributed, and each call require an equal amount of resources. Each base station measures the average rate of arrival handoff requests. It then uses a M/M/1 queuing model to estimate the number of channels required for handoff calls, where the number of required radio channels is modeled as the number of buffers in the queue. Other local methods can also be found in, for example, L. Ortigoza-Guerrero, A. H. Aghvami, “A Prioritized Handoff Dynamic Channel Allocation Strategy for PCS”, IEEE Transactions on Vehicular Technology, Vol. 48, Bo. 4, July 1999 and S. Kim, T. F. Znati, “Adaptive Handoff Channel Management Schemes for Cellular Mobile Communication Systems”, ICC'99.

Existing local methods pose a number of potential problems. First, they can only handle “homogeneous” radio channels, i.e., radio channels with the same allocated capacity. In wireless IP networks that support multiple services (e.g., data, voice, and video), capacity allocated to each radio channel will vary widely depending on the type of service the channel supports or even within a single service type (e.g., channels with different capacities can be used to support different data services). Second, they assume that handoff and new call arrival processes to be Poisson and stationary in the mean (i.e., the mean is the same over time) and that the handoff call holding time inside each cell to be exponentially distributed. These conditions may not hold in a real wireless network, especially in wireless IP networks that often consist of a large number of very small cells (e.g., picocells). In such networks, handoff becomes more frequent, handoff call arrivals are likely to be non-Poisson and non-stationary for extended periods of time. In fact, even in today's macrocellular networks, handoff call arrivals may not be Poisson for extended periods of time. The average handoff call holding time inside each cell is often non-exponentially distributed. The mean handoff call arrival rates will not remain the same either. Instead, they will change as changes occur in, for example, the number of mobile stations, user mobility pattern, and available services or network configuration.

The limitations of existing methods are primarily caused by a fundamental principle used in these methods: they do not model the resource demands of handoff calls directly; Instead, they model the factors (e.g., handoff call arrival process, call holding time, types of calls, mobility patterns of the users) that impact the demand and then derive the resource demands of future handoff calls from the model of the impacting factors. This leads to two fundamental limitations. First, in a real multimedia wireless IP network, a large number of factors can impact the resource demands of future handoff calls. The set of impacting factors often change over time and the interactions among these factors can be very complex. Consequently, modeling these factors can be prohibitively difficult. Second, to cope with the complexity of modeling the impacting factors, existing methods have to make stringent assumptions on how the impacting factors behave, how they interact with each other, and how they impact the amount of resources required by handoff calls. Many of these assumptions are not true in real networks, especially not true in multimedia wireless IP networks. For example, almost all existing methods assume that handoff calls arrivals at a cell follow a Poisson process and are stationary in the mean (i.e., the mean arrival rate remains constant over time). In a real network, especially in a network that consists of a large number of small cells, handoff call arrivals are likely to be non-Poisson for extended periods of time. Furthermore, the mean handoff call arrival rate in a real network will typically increase over time as more subscribers are added to the network or as users are becoming more mobile. Most existing methods also assume that a call will remain active for an exponentially distributed amount of time in each cell the user moves into. This is often not true in real networks. For example, if a user moves at constant speed through several cells, the time the user's call remains active in each cell will be a constant. Third, due to the large number of impacting factors and the complex interactions among them, most existing methods can only estimate the long-term averages of the amount of resources required for handoff calls. Consequently, their estimation often cannot be easily adjusted to respond to the fluctuation of demands.

Furthermore, current approaches to resource reservation reserve radio resources only and make reservation decisions independent of upper layer (e.g., IP layer) resource availability. This could lead to low resource utilization and poor system performance when IP-based base stations are used. For example, current approaches may reserve radio resources for a new call that requires high bandwidth only to determine that the IP-layer does not have sufficient resources to support the call. Meanwhile, the radio resources have been allocated to the high-bandwidth call and could cause a large number of new low-bandwidth calls (which can be supported at all protocol layers) to be rejected. Furthermore, resource reservation in today's wireless networks is typically performed inside the radio system (e.g., at the radio resource control layer in CDMA networks). This makes it difficult for simultaneous reservation of radio resources and IP-layer resources because lower layer protocols (i.e., radio layer protocols) will have to request resource reservations at higher layers of the protocol stack (i.e., IP layer protocol), which violates basic principles of protocol layering.

Furthermore, existing handoff resource reservation methods are unsuitable for IP-based multimedia wireless networks. First, the amount of bandwidth required to successfully handoff a call in an IP-based multimedia wireless network could be arbitrary (up to the limit of the radio system) and can vary over a wide range. This is especially true when applications/calls can adapt to different levels of service quality and therefore may accept different levels of resources in order to achieve successful handoff as many data or video applications already do. Second, Wireless IP networks are often envisioned to support high-capacity picocells, where handoffs are more frequent than in today's macrocellular networks and handoff demands are likely to be non-stationary for extended periods of time. In fact, even in today's macrocellular networks, handoff call arrivals may not necessarily be a Poisson process but may often be non-stationary for extended periods of time. Third, Wireless IP networks will likely use IP-based wireless base stations—base stations that perform IP-layer processing (e.g., IP packet routing). This suggests that both radio resources (e.g., radio channels) and IP-layer resources (e.g., bandwidth) need to be reserved in a consistent manner for handoff calls.

### SUMMARY

It is therefore an object of the present invention to provide a method for localized dynamic resource reservation in wireless networks that overcome the limitations of the prior art.

Our method uses only local information to determine the amount of resources that should be reserved for handoff calls and new calls originating within a cell. Accordingly, a base station employing our method does not have to communicate with other base stations for resource reservation decisions. In this way, base stations can function autonomously as is expected for future IP wireless networks.

Our method models and predicts the values of future demands directly. Other methods do not model the resource demands directly. Instead, they model (typically using queuing theories) the factors (e.g., arrival process of handoff calls, call holding times, types of calls) that impact the resource demands, then derive the resource demands from the model of the impacting factors. Modeling the demands directly enables our method to easily handle any arbitrary call arrival process (including non-Poisson and non-stationary processes), allows calls to require any arbitrary amount of resources, and allows calls to have any arbitrary call holding time distribution in each cell.

Our method models the instantaneous values of the resource demands of future handoff and new calls. This enables our method to predict the instantaneous and/or average values of future resource demands. Other existing methods can typically only model and predict average demands. Modeling instantaneous demands enables our approach to respond to demand fluctuations easily and more rapidly than other methods that are based on determining average values.

Our method can be used to determine the future demands and resource reservation levels of any type of calls (e.g., new calls); the method is not limited to handoff calls.

Our method can be used to determine the future demands and resource reservation levels for any type of traffic or service (e.g., video service, voice service, any data service). Our method can also be used to determine the total resource demands and resource reservation levels for multiple traffic or service types without having to estimate the demands for each traffic or service type separately.

Our method can be used to determine the future demands and reservation levels of any type of resource (e.g., radio channels, radio capacity, number of IP addresses, IP-layer capacity). Our method can also be used to determine the total demands and reservation levels of multiple types of resources without having to determine the resource demand and reservation levels of each resource type separately.

Our method can be used to determine the future demands and reservation levels of the resources at any protocol layer (e.g., radio layer resources, IP layer resources). Our method can also be used to determine the total demands and reservation levels of resources at multiple protocol layers without having to determine the resource demand and reservation levels at each individual protocol layer separately.

Our invention reserves radio resources and IP-layer resources automatically. In other words, the proposed method reserves a matching amount of radio resources and IP-layer resources at the same time. The reservation at each layer is committed if and only if sufficient resources at both layers can be reserved. This can increase overall resource utilization and reduce handoff call blocking probability.

Our invention is simple and can therefore be easily implemented in current and future wireless networks. In addition, our method may be implemented in any radio network, including both Time Division Multiple Access (TDMA) and Code Division Multiple Access (CDMA) wireless networks. Finally, our method is applicable regardless of whether handoff is soft or hard.

### BRIEF DESCRIPTION OF THE DRAWINGS

FIG. 1A illustrates a prior art cellular network;

FIG. 1B depicts a prior art network executing soft handoff;

FIG. 1C illustrates a future Internet Protocol (IP) based autonomous wireless base station cellular network;

FIG. 2 illustrates multi-layer reservation in accordance with an aspect of our invention;

FIG. 3 is a flow chart of the method steps for multi-layer reservation in accordance with an aspect of invention;

FIG. 4 plots actual and predicted bandwidth requirements for handoff calls as a result of a simulation done in accordance with an aspect of our invention assuming receiving 5 handoff call requests per minute and updating every 10 minutes;

FIG. 5 plots actual and predicted bandwidth requirements for handoff calls as a result of a simulation done in accordance with an aspect of our invention assuming receiving 5 handoff calls per minute and updating every 5 minutes;

FIG. 6 plots actual and predicted bandwidth requirements for handoff calls as a result of a simulation done in accordance with an aspect of our invention assuming receiving 2 handoff calls per minute and updating every 10 minutes; and

FIG. 7 plots actual and predicted bandwidth requirements for handoff calls as a result of a simulation done in accordance with an aspect of our invention assuming receiving 2 handoff calls per minute and updating every 5 minutes.

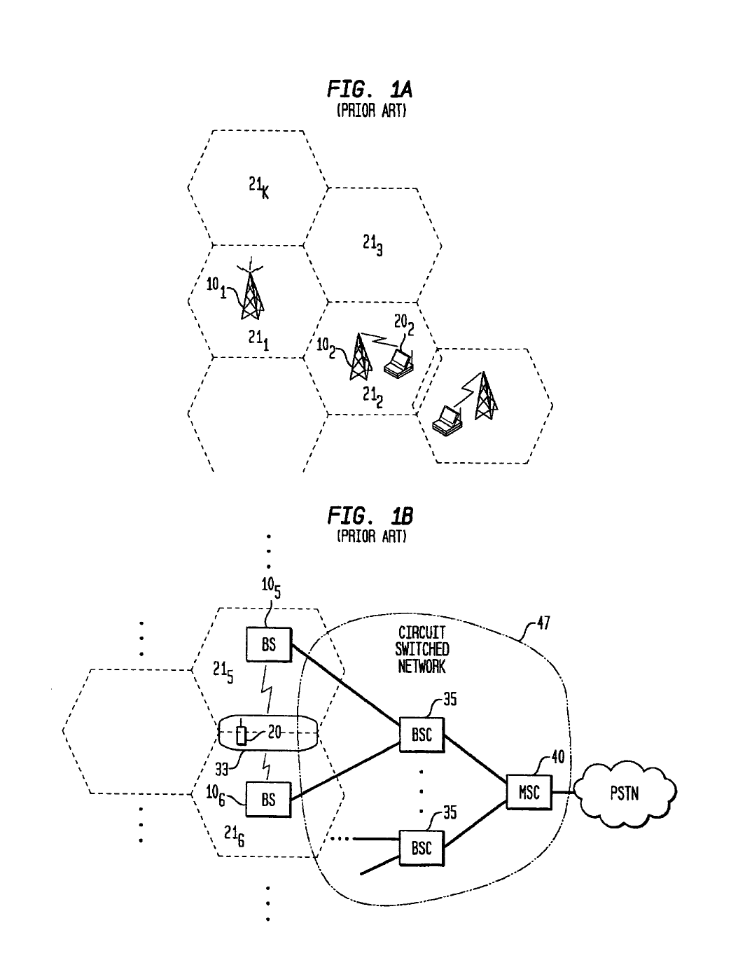

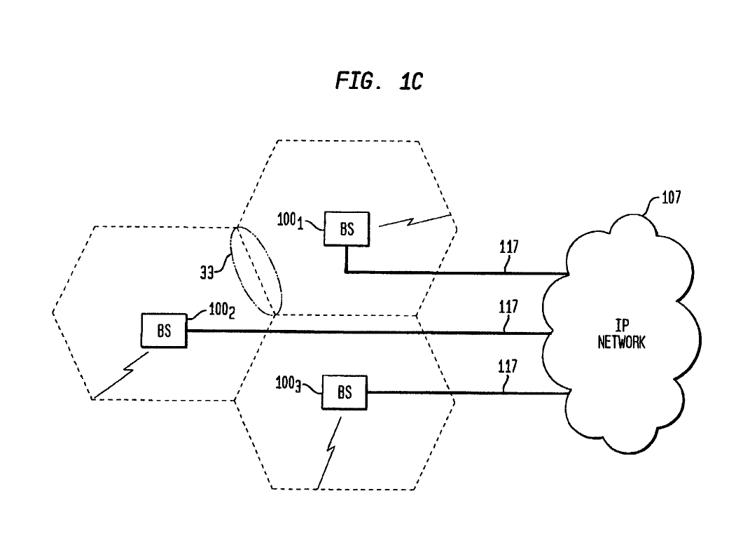

### DETAILED DESCRIPTION

In the discussions to follow we will again refer to different layers of the 7-layer Open System Interconnect (OSI) reference model wherein the layers are ordered as follows: layer 1 is the physical layer and the lowest layer in a stack, layer 2 is the link layer and above layer 1, layer 3 is the network layer and above layer 2, layer 4 is the transport layer and above layer 3, layer 5 is the session layer and above layer 4, layer 6 is the presentation layer and above layer 5, and layer 7 is the applications layer and the highest layer.

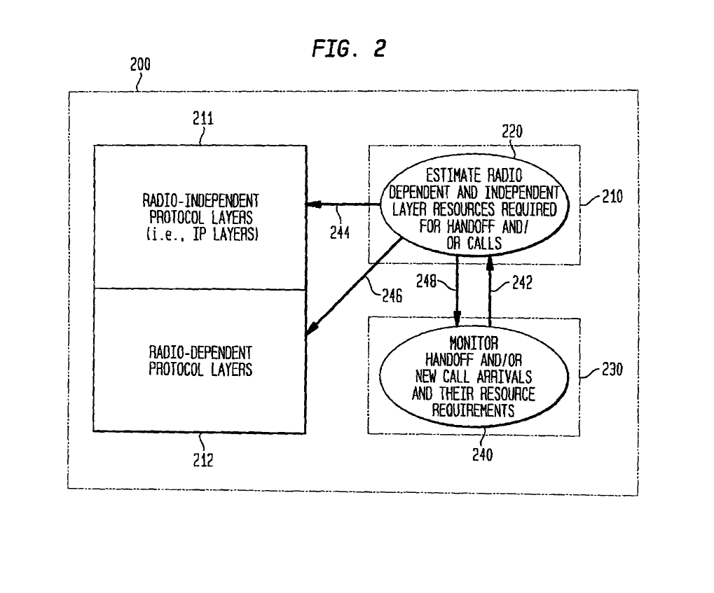

Turning to FIG. 2 there is illustrated an aspect of our invention that we refer to as Multi-Layer Reservation. As discussed above, prior art approaches to resource reservation reserve radio resources only and make reservation decisions independent of upper layer (e.g., IP layer) resource availability. In addressing this shortcoming of the prior art we move the function of estimating the amount of resource required for calls in a base station 200 from the radio-dependent layers to a software entity referred to as a reservation handler 210 that resides at a radio-independent layer 211 as illustrated in FIG. 2. The reservation handler 210 estimates the resources required to support future calls originating with a cell as illustrated by functional element 220 both for radio-independent and dependent layers 211 and 212, respectively.

Note, the reservation handler 210 may estimate the amount of resources needed for both handoff calls and new calls originating within the base station's cell. On the other hand, the reservation handler 210 may estimate the amount of resources needed for either handoff calls or new calls originating within the base station's cell. The choice whether to use both or one type of call is an implementation detail for the discretion of the network operator.

The resource reservation estimate is based on data provided by a handoff and/or new call monitor 230 in the base station radio system. Monitor 230 monitors handoff and/or new call requests, resource requirements, and resource usage as illustrated by functional element 240. The data gathered during a monitoring interval as requested by reservation handler 210, see arrow 248, is directed or provided to the reservation handler 210, see arrow 242. The reservation handler 210 uses the data to estimate the radio dependent and independent resources required to support the handoff and new call requests. Based on the estimate the reservation handler 210 then instructs, arrows 244 and 246, the radio independent and dependent layers 211 and 212, respectively, to reserve these estimated resources for future handoff and new calls.

In accordance with our Multi-Layer Reservation method sufficient resources are reserved at all protocol layers or no resources are reserved at any protocol layer. In addition, our method reduces handoff blocking probability.

The reservation handler 210 estimates or predicts the amount of resources to be reserved based on a stochastic model, such as our model developed below. To overcome accumulating estimation errors over time, the reservation handler 210 will periodically instruct, see arrow 248, the monitor 230 to gather the actual amount of resources used for calls during fixed time periods (for example every T⁰_{update} minutes). The results will be used by the reservation handler to reset the stochastic model it uses for predicting the amount of resource required for future handoff and new calls.

When the actual amount of resources needed by handoff and/or new calls fluctuate rapidly, periodic measurements by the handoff monitor 230 alone may not be sufficient to capture the changes in the amount of resources needed for future calls. In order to avoid this problem, a significant change in the actual amount of resources requested for calls between two consecutive periodic resource usage measurements triggers the reservation handler 210 to instruct the monitor 230 to collect call resource usage data or information more frequently, i.e., T_{update}=T⁰_{update}−ΔT. For example, let Δr represent the difference in resource usage between two consecutive resource usage updates. In addition, let R_{d} represent a threshold value. If Δr≧R_{d}, the handoff monitor will be triggered to collect resource usage information at shorter time intervals. Thus, the prediction model will be reset more often during unstable periods when the actual resource usage by handoff and/or new calls varies drastically.

When consecutive periodic updates do not fluctuate by a great amount, Δr<R_{d}, the reservation handler 210 instructs the monitor 230 to collect resource usage information over longer time periods because the system is expected to be in a more stationary state. The reduced frequency of resource usage updates during stable periods avoids unnecessary overhead. The dynamically adjusted frequency of updates during unstable periods enables the prediction model to forecast rapid resource demand changes more accurately.

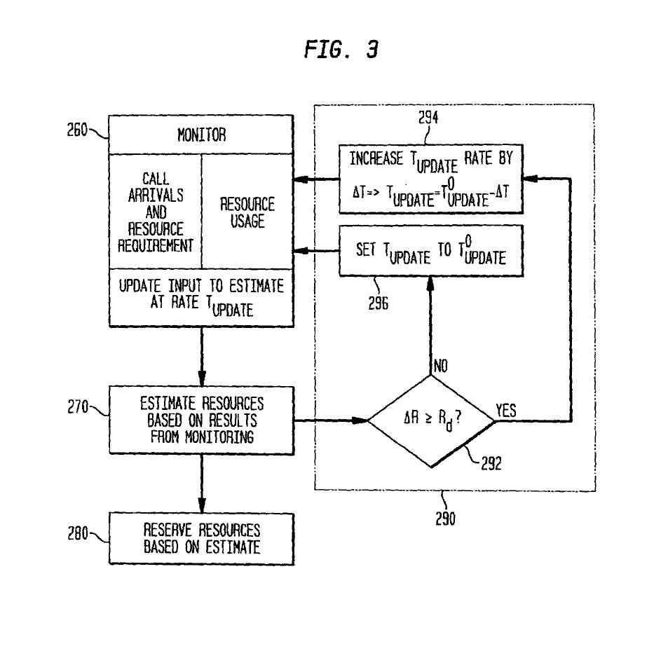

In FIG. 3 we illustrate the steps of multi-layer reservation in a flow chart. At block 260, handoff and/or and new call arrivals, resource requirements, resource usage are monitored by monitor 230. The data gathered during monitoring is then used to estimate the resources required to support handoff and/or new calls, block 270, by reservation handier 210. The estimate is then used to reserve resources at all layers, block 280, and to update the monitoring process, block 290, based on the actual resources used. As discussed above, if the difference in resource usage, ΔR, is greater than or equal to a threshold value, R_{d}, as illustrated at diamond 292, then resource usage monitoring takes place more frequently, block 294. Therefore, if resource usage data was being monitored, and forwarded to block 270 for estimating, at a rate of T⁰_{update}, then the update rate is increased by ΔT. Consequently, resources are reserved more frequently at block 280 by reservation handler 210 communicating with the radio independent and dependent layers 211 and 212.

On the other hand, if the difference in resource usage is less than R_{d}, then the resource usage monitoring is done less frequently, for example at rate T⁰_{update}, as is illustrated at block 296.

Note our method is readily applicable in wireless networks that employ either soft or hard handoff.

We will now turn to another aspect of our invention that improves on the prior art and our Multi-Layer Reservation method described above. As discussed above, prior art methods that use only location information to estimate future resource reservation model the factors (e.g., arrival process of handoff calls, call holding times, types of calls) that impact the resource demands, then derive the resource demands from the model of the impacting factors. We propose a new resource prediction and reservation method that overcomes the limitations of existing methods by using Wiener estimation-based stochastic models to directly model the instantaneous amount of resources needed for handoff calls.

We model the total amount of resources, R(t), required to support handoff and/or new calls in a cell at time t as a stochastic process. R(t) can represent, for example, the number of radio channels, the amount of bandwidth, or the number of IP addresses required to support calls. The idea is to use the current and past values of R(t) to predict the future values of R(t). Since the current and past values of R(t) can be measured by a base station locally without exchanging any information with other base stations, estimating the future values of R(t) can be carried out using only local information.

We use Wiener process-based stochastic models to model R(t). A Wiener process is a Markov process where only the present value is relevant for predicting the future. It has been successfully used to model stochastic processes where the value of a random variable is affected by a large number of factors, each with a small impact. For example, the Wiener process has been used in physics to model the motion of a particle that is subject to a large number of small molecular shocks (which is sometimes referred to as Brownian motion). It has also been widely used to model the behavior of stock prices. The amount of resources required to support handoff and new calls share many similar properties with Brownian motion and stock prices—it is a random variable whose value changes over time and the change is impacted by a large number of factors, each with a small impact. For example, such factors include, sizes of the cells, the number of mobile stations in each cell, speed and mobility pattern of each mobile station, types of services supported by the cells, type and number of services used by each mobile station at any given time, etc. These characteristics suggest that the Wiener process could be an effective way to model R(t).

Let Δt be the prediction time interval. Using the basic Wiener process, R(t) can be modeled as in Equation (1).

ΔR=R(t)−R(t−Δt)=α\sqrt{Δt} (1)

where α is a random value drawn from a standard normal distribution (i.e., a normal distribution with a mean of zero and a standard deviation of 1.0). The basic Wiener model in Equation (1) has the following main properties, which hold regardless of the value of Δt.:

1. the value of ΔR for any given time interval Δt is independent of the starting time of Δt,

2. the values of ΔR for any two different time intervals Δt₁ and Δt₂ are independent, and

3. the mean and standard deviation of ΔR are 0 and \sqrt{Δt}, respectively.

Many variations of the basic Wiener model exist and may be used to model more complex resource demand processes. For example, the model in Equation (2) allows the mean and the standard deviation of ΔR to change over time.

ΔR=μΔt+αδ\sqrt{Δt} (2)

where μ is a constant referred to as the expected change rate of ΔR and δ is a constant referred to as the standard deviation rate of ΔR. ΔR, as expressed in Equation (2), is a normally distributed random variable with mean μΔt and standard deviation δ\sqrt{Δt}. Those of ordinary skill in the art will note that other variations of the Weiner model may also be used.

For any given time interval τ, μ and δ can be estimated using any statistical estimation techniques. For example, μ and δ can be estimated based on the mean and the variance of the sample values of ΔR in previous time intervals of length τ. A sample value of ΔR can be a measured actual value or a predicted value of ΔR. Let t be the current time, then μ and δ can be estimated by setting μτ and δ\sqrt{τ} to the mean and standard deviation, respectively, of the sample values of ΔR in the previous k time intervals: [t, t−τ], [t−τ, t−2τ], . . . , [t−(k−1)τ, t−kτ]. Let r(x) be the sample value of R(x), the sample value of ΔR in time interval [t−iτ, t−iτ−τ] will be r(t−iτ)−r(t−iτ−τ), i=0, . . . k−1. The estimated value \hat{μ} of μ will be given by Equation (3).

$$\hat{μ} = \frac{{\sum }_{i = 0}^{k - 1} ( r ( t - i τ ) - r ( t - i τ - τ ) )}{k τ} = \frac{r ( t ) - r ( t - k τ )}{k τ} \qquad ( 3 )$$

The estimated value \hat{δ} of δ will be given by Equation (4).

$$\hat{δ} = \frac{1}{\sqrt{τ}} \sqrt{\frac{{\sum }_{i = 0}^{k - 1} {( r ( t - i τ ) - r ( t - i τ - τ ) - \hat{μ} τ )}^{2}}{k}} \qquad ( 4 )$$

Since ΔR is normally distributed, we should achieve satisfactory estimates of μ and δ if k is 25 or larger.

The sampling time interval τ for estimating μ and δ does not have to be the same as the prediction time interval Δt used by a base station to predict future resource demands. To reduce sample collection time, accurate estimates of μ and δ can be obtained using samples of ΔR taken more frequently than one sample in each prediction time interval. Suppose, for example, that resource prediction is performed every Δt=10 minutes, but the actual resource demand levels are sampled every τ=1 minute. Then, μ and δ can be estimated using the 25 sample values of ΔR, each taken in one of the past 25 minutes, rather than the sample values of ΔR, each taken in one of the last 25 prediction time intervals. As a result, μ and δ can be estimated using the samples of ΔR taken during a 25-minute time window rather than a 250-minute time window.

Suppose that a base station knows the value of R(t), the amount of resources required for all handoff calls at time t. The amount of additional resource ΔR required at a future time t+Δt (or over a future time period Δt) for handoff calls can be predicted based on R(t) and the predicted values of ΔR for the time interval Δt. Any point or interval predictions of ΔR may be used. Using Equation (2), an unbiased minimum variance estimate of ΔR is \hat{μ}Δt. The point value generated directly by Equation (2) can also be used a point prediction of ΔR. Accuracy of the point estimate depends on δ and the prediction time interval Δt. To provide a confidence level in the estimates, we can use interval prediction. The confidence level for a predicted interval (i.e., a confidence interval) of ΔR is the probability that the actual demand falls inside the predicted interval. Since ΔR is modeled as a normal random variable for any given prediction time interval Δt, the confidence interval for any given confidence level can be determined easily based on \hat{μ} and \hat{δ}.

Interval prediction allows us to predict the worst-case dropping probability P of handoff calls. In particular, we can determine a level L such that Prob( ΔR≦L)=1−P. This level L is called a (1−P)* 100% upper confidence bound for ΔR. If this level L is used to set resource reservation levels, we have a statistical guarantee that the handoff dropping probability in the next time interval Δt is P.

A base station can learn the current and past value of R(t) by monitoring the amount of resources requested by handoff and/or new calls during an initial period of time. The initial value is then used in the Wiener model to predict future demands. The predicted demand at any time t may also be used to predict future demands.

The use of Wiener process models enables our method to model and predict the instantaneous values of the resource requirements of future handoff calls directly. As such, our method can easily handle any arbitrary handoff call arrival process (including non-Poisson and non-stationary processes) and allows calls to require any arbitrary amount of resources and to have any arbitrary call holding time distribution in each cell a user travels into. These capabilities can not be achieved by prior art methods. Moreover, modeling instantaneous demands enables our approach to respond to demand fluctuations more rapidly than prior art methods by dynamically changing the values of the parameters in our model and by increasing or decreasing the rate at which the predictions are generated and resources are reserved; this is shown as block 290 in FIG. 3. Furthermore, because each base station records the actual amount of resource required for handoff calls periodically or as triggered by significant events (as explained above) and uses the actual values to reset the prediction model, prediction error does not accumulate significantly over time.

In an effort to determine the effectiveness of our method in reserving the total amount of bandwidth required to support handoff calls of multiple service types we performed a numerical analysis (via simulations) of our method. We will now describe the results of those simulations.

In simulating our method we assume handoff call arrivals to be Poisson (because a Poisson process is simpler and requires less computational resources). We considered two mean handoff call arrival rates: λ=5 and 2 handoff calls per minute. For both handoff call arrival rates, the amount of bandwidth needed to successfully handoff a call is assumed to be between 16 kbps and 56 kbps. We also assume that in each minute there is a 10% probability that a very high bandwidth call is handed off into the cell. We assume that each handoff call remains active in the cell for an exponentially distributed holding time with an average time of 10 minutes. For the actual handoff call bandwidth usage, we created two sets of simulated values, one for each λ value. For each mean handoff call arrival rate, we simulated handoff arrival rates, call holding times and call bandwidth requirements using random number generators with the appropriate distributions and mean values. We then used MATLAB to implement our prediction model based on Equation (3) and to determine the predicted bandwidth requirements for handoff calls.

The above assumptions on handoff arrival rates, call holding times and call bandwidth needs can represent, for example, the following scenario in a real network. The network supports voice services at about 16 kbps, Internet access services at a number of data rates ranging from 16 kbps to 56 kbps, and a real-time video service at 384 kbps. Furthermore, the majority of mobile calls are calls for Internet access and a small percentage of users use video service.

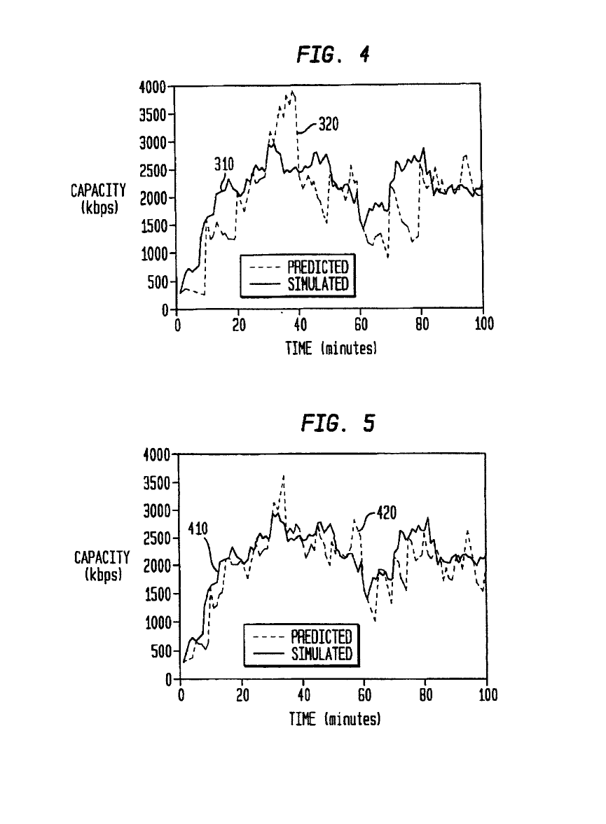

FIG. 4 shows the simulated actual bandwidth usage 310 for all handoff calls in the cell (including any on-going call that is in the cell because of a handoff) and the predicted values 320. FIG. 4 assumes that λ=5 handoffs per minute. The prediction is performed once every minute, i.e., Δt=1 minute. The update interval T_{update} is assumed to be 10 minutes. In other words, starting from time t=0, the resource requirements for the next minute will be predicted based on either the actual or the predicted demands for handoff calls during the current minute. Furthermore, once every ten minutes, the base value for the prediction model is reset to the simulated actual bandwidth requirements of the handoff calls. The actual demands in this case happens to be stationary in the mean after the initial system startup time period. Therefore, the means of R(t) and R(t+Δt) should be the same for any t and Δt, which means that μ in Equation (2) can be set to zero. The average percentage difference between the predicted values and the simulated values is 22.4%±19.6%. FIG. 5 shows the actual 410 and the predicted 420 amount of bandwidth required for handoff calls when we shorten the update interval to 5 minutes while leaving all other parameters unchanged. In this case, the percentage average difference between the predicted and the simulated values reduces to 13.5%±13.8%.

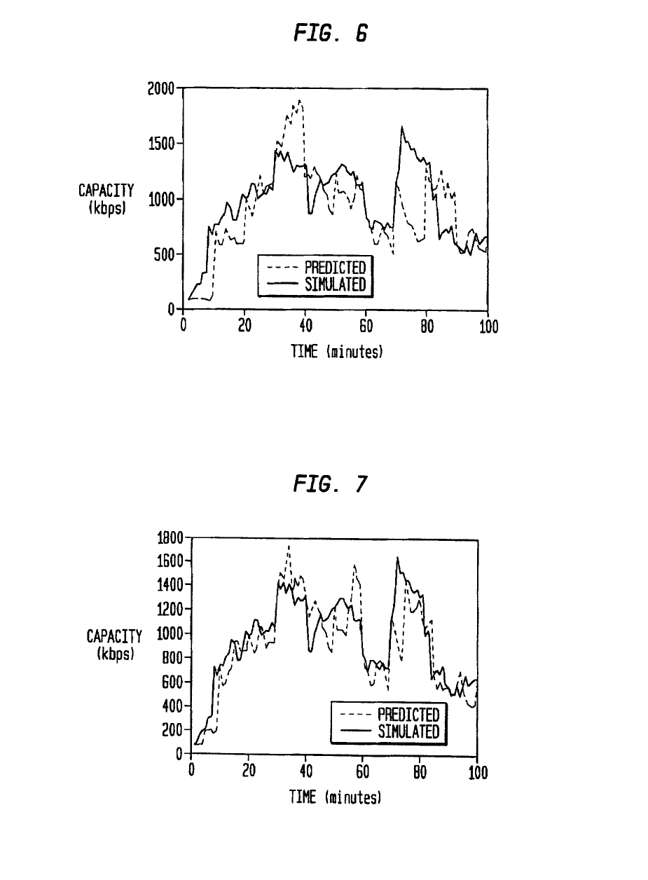

FIG. 6 and FIG. 7 show the actual and the predicted bandwidth requirements for handoff calls when λ=2 handoffs per minute. FIG. 6 assumes that T_{update} is equal to 10 minutes and FIG. 6 assumes T_{update} is equal to 5 minutes. In both FIGS. 6 and 7, μ=0 and Δt=1 minute. When T_{update}=10 minutes, the average percentage difference between the predicted values and the simulated values is 24.7%±22.6%. When the update interval is 5 minutes, the percentage difference is on average 16.7%±16.7%. The average percentage difference is higher in the cases reported here when λ drops to 2 handoffs per minute. This is because too few handoff calls occur when λ=2 handoffs per minutes, but the bandwidth required for each handoff call continues to vary over a wide range and the probability of very high bandwidth requirements remains the same. Consequently, the handoff traffic becomes more bursty. Despite the increased burstiness, our reservation method continues to performs reasonably well.

Our simulations show that when the average handoff arrival rate and/or the traffic holding time increases, the handoff resource usage becomes smoother. In such cases, our method can generate close predictions for a longer time. Therefore, the prediction model can be reset less frequently than when the handoff bandwidth demands are more bursty. In general, the update interval T_{update} can be varied to capture the burstiness of traffic. The value of T_{update} can be changed using the triggering mechanism described above.

Note that results from earlier investigations would have incorrectly estimated the bandwidth values by a larger amount since they were based on average values. When the network must handle calls that may require high bandwidth for relatively short periods of time, the bursty nature of the bandwidth requirements can not be effectively captured with average values. For example, for the set of simulated values used in FIG. 4 when λ=5 handoffs per minute, the average handoff call bandwidth requirement would be about 2128.7 kbps. If this value was used to reserve resources, then the percentage difference between the actual and the reserved values would be about 33% with a standard deviation of about 84%. For the set of simulated values determined when λ=2 handoffs per minute, the average bandwidth required for handoff calls would be about 955.2 kbps and the average percentage difference increases to approximately 60%.

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

We claim:

1. A method for reserving resources in a wireless network, said method comprising the steps of:
monitoring a resource to obtain a resource value;
estimating resources needed for radio dependent and radio independent layers based on said monitored resource value; and
reserving said needed resources at the radio dependent and radio independent layers based on said estimate.

2. The method of claim 1 wherein said monitoring step further includes the step of monitoring call arrivals, resource requirement, and resource usage.

3. The method of claim 2 further comprising the step of updating the rate at which said estimating is done if the difference in resource usage is greater than or equal to a pre-determined value.

4. The method in accordance with claim 3 wherein said step of estimating further includes the step of modeling the resources needed as a Wiener process.

5. The method in accordance with claim 3 said calls are handoff calls.

6. The method in accordance with claim 3 wherein said calls are new calls originating within a cell.

7. The method in accordance with claim 3 wherein said calls are handoff calls and new calls originating within a cell.

8. A method for reserving resources in a mobile wireless internet protocol network, said method comprising the steps at a base station of:
monitoring call arrivals and resource requirements;
responsive to said monitoring, estimating the radio dependent and radio independent resources required; and
instructing radio independent and radio dependent layers to reserve the estimated resources for future calls.

9. The method in accordance with claim 8 wherein said estimating step resides at a radio-independent layer of the internet protocol.

10. The method in accordance with claim 8 further comprising increasing the rate of said monitoring step if the difference in resource usage is greater than or equal to a threshold value.

11. The method in accordance with claim 10 wherein said estimating step comprises Wiener process-based stochastic models.

12. The method in accordance with claim 11 wherein said estimating step resides at a radio-independent layer of the internet protocol.

13. The method of claim 12 wherein said calls are handoff calls.

14. The method in accordance with claim 12 wherein said calls are new calls originating within a cell.

15. The method in accordance with claim 12 wherein said calls are handoff calls and new calls originating within a cell.

16. The method in accordance with claim 8 wherein said step of monitoring monitors instantaneous values of handoff call arrivals and resource requirements.

17. The method in accordance with claim 8 wherein said instructing step causes reservation of both radio resources and internet protocol layer resources.

18. The method in accordance with claim 17 wherein said estimating step is based on a stochastic model.
